(19) United States
(12) Patent Application Publication
(10) Pub. No.: US 2026/0250587 A1
(43) Pub. Date: Aug. 27, 2026

(54) METHOD FOR OBTAINING A SYNTHESIS GAS FROM WASTE PRODUCTS VIA A GASIFICATION REACTION IN CONJUNCTION WITH A REFORMING REACTION WITH THERMAL ENERGY RECIRCULATION

(71) Applicant: Cyclize GmbH, Leinfelden-Echterdingen (DE)

(72) Inventor: Stephan RENNINGER, Stuttgart (DE)

(73) Assignee: Cyclize GmbH, Leinfelden-Echterdingen (DE)

(21) Appl. No.: 19/548,771

(22) Filed: Feb. 24, 2026

(30) Foreign Application Priority Data
Feb. 25, 2025 (DE) 10 2025 107 088.1

(51) Int. Cl. C10J 3/72; B01D 53/68; B01D 53/81; C01B 3/34; C10J 3/84; C10J 3/86

(52) U.S. Cl. CPC C10J 3/723; B01D 53/685; B01D 53/81; C01B 3/342; C10J 3/845; C10J 3/86; B01D 2251/602; B01D 2251/604; B01D 2251/606; B01D 2257/2045; B01D 2257/2047; B01D 2258/0283; C01B 2203/0216; C01B 2203/0222; C01B 2203/062; C01B 2203/0833; C01B 2203/0861; C01B 2203/1235; C01B 2203/1671; C10J 2300/0946; C10J 2300/0969; C10J 2300/0976; C10J 2300/1246; C10J 2300/1269; C10J 2300/1618; C10J 2300/1807; C10J 2300/1884; C10J 2300/1892

(57) ABSTRACT

Disclosed are methods and devices for obtaining a synthesis gas from a waste product via a gasification reaction in conjunction with a reforming reaction under thermal energy recirculation. A feed material and a first and/or second oxidizing agent are fed into a gasification reactor. The feed material includes a solid, liquid and/or gaseous waste product. The feed material is gasified by the first and/or second oxidizing agent, with the addition of thermal energy, into a hydrocarbon gas mixture and at least one by-product including bottom ash and/or fly ash. The hydrocarbon gas mixture is fed into a reformer unit and processed into a raw synthesis gas with the first and/or second oxidizing agent. At least part of the thermal energy released by processing the raw synthesis gas is recirculated into the gasification reactor to provide at least part of the thermal energy for gasification of the feed material.

### CROSS-REFERENCE TO RELATED APPLICATIONS

This application claims the priority of German Application No. 10 2025 107 088.1, filed Feb. 25, 2025, the entire contents of which are incorporated herein by reference.

### FIELD OF THE DISCLOSURE

The present invention relates to a method and device for obtaining a synthesis gas from waste products via a gasification reaction in conjunction with a reforming reaction with thermal energy recirculation.

### BACKGROUND OF THE DISCLOSURE

Large-scale production of fossil-based synthesis gas currently takes place in energy-intensive processes such as natural gas reforming or coal gasification. Synthesis gas is defined here as a gas mixture of carbon monoxide (CO) and hydrogen (H2). However, various novel processes for obtaining synthesis gas are currently still associated with shortcomings.

In biogas reforming, for example, the synthesis gas is produced decentrally, which leads to high costs due to smaller plants, high investment and operating costs, and logistical inefficiencies. This results in significantly higher prices for synthesis gas compared to natural gas.

Processes that use electrolysis in combination with a water gas shift reaction or co-electrolysis require a very high amount of electrical energy and have low energy efficiency, which in turn leads to high prices for the resulting synthesis gas.

Thermally operated waste-to-syngas processes use the oxidation and combustion of part of the waste raw material to provide the energy required for thermal reforming to produce syngas. This results in high carbon dioxide emissions from the process, which cannot be efficiently utilized in downstream processes.

In thermal processes for obtaining synthesis gas from waste material, it is known that carbonaceous waste materials are converted into synthesis gas with the addition of oxidizing agents such as oxygen or water vapor, whereby gasification takes place first. The gaseous fractions produced during gasification have different chain lengths. Some of these are condensed and marketed as a substitute for crude oil. After gasification, the gaseous fractions can be used to generate heat and electricity. However, in terms of economic efficiency in industrial applications, the requirements for the individual fractions and the composition of the waste products used are very high, which is why existing gasification plants are specialized in the type or different purities of the waste product and are therefore limited. In addition, the valuable by-products of gasification, such as various types of ash, such as bottom ash, fly ash, or pond ash, cannot be reused. Furthermore, a potentially fluctuating supply of waste products is detrimental to the safe and gentle operation of the gasification reactor. This also makes it difficult to ensure a constant supply of a product stream of hydrocarbon mixture.

Furthermore, processes for refining unpurified raw gases via reforming are known, which convert hydrocarbon-containing gas mixtures into a synthesis gas that is purified of pollutants and richer in hydrogen, but there is no recycling of materials already used from waste management. In known reforming processes, hydrocarbon mixtures such as natural gas, light gasoline, methanol, or even biomass are reformed into synthesis gas as starting materials with an oxidizing agent, for example, water vapor, under the application of heat.

Overall, known processes involve high energy consumption throughout the entire process chain from the primary energy source to the final product, which would make electrification uneconomical. This can be explained, for example, by high losses of waste heat, unused feed material, or unused oxidizing agent. Non-electrical processes that use waste lead to the formation of carbon dioxide and the successive emission of this pollutant through the use of oxygen or air as an oxidizing agent. This in turn leads to a reduction in the quality of the synthesis gas.

### SUMMARY OF THE DISCLOSURE

Based on the known state of the art, the objective of the present invention is to provide an improved process for obtaining a synthesis gas from waste products via a gasification reaction in conjunction with a reforming reaction under thermal energy recirculation, as well as a corresponding device.

The focus is particularly on increasing energy efficiency and minimizing by-products. One objective of the invention is therefore to provide an improved process and an improved system for obtaining a synthesis gas from waste products, which aims at the efficient use of waste and the minimization of energy consumption.

The task is solved by a method according to claim 1. Advantageous further developments result from the subclaims, the description, and the figures.

Accordingly, a method for obtaining a synthesis gas from at least one waste product via a gasification reaction in conjunction with a reforming reaction under thermal energy recirculation is proposed. The process comprises a first step S1 of feeding a feed material and a first and/or second oxidizing agent into a gasification reactor, wherein the feed material comprises in particular at least one solid, liquid, and/or gaseous waste product. The process also comprises a second step S2 of gasifying the feed material in the gasification reactor by means of the first and/or second oxidizing agent with the addition of thermal energy into a hydrocarbon gas mixture, wherein at least one by-product is produced, wherein the by-product comprises, in particular, bottom ash and/or fly ash. The process further comprises a third step S3 of feeding the hydrocarbon gas mixture from the gasification reactor into a reformer unit and a fourth step S4 of processing the hydrocarbon gas mixture in the reformer unit into a raw synthesis gas with the addition of the first and/or second oxidizing agent, and wherein at least a portion of thermal energy generated in step S4 is recirculated to the gasification reactor to provide at least a portion of the thermal energy supplied in step S2.

The term waste product is to be understood herein as the reactant of the process for obtaining a synthesis gas. Usually, the suitable reactants are those that are produced as waste products in previous processes. However, the latter is not a mandatory requirement for suitability for the present process for obtaining synthesis gas. Thus, the term “waste product” herein also includes a reactant that is not actually obtained from waste, but has been specifically produced.

Waste products here are understood to be, in particular, carbon-containing substances, especially methane, propane, biogas, plastics, residual waste, wood waste, biomass, lignin, and/or paper waste, or mixtures of substances containing the above substances, which arise, among other things, from previous processes, in particular cracking, recycling, and/or Fischer-Tropsch synthesis, as residual material, by-product, and/or co-product.

Coupling a reformer unit with an upstream gasification reactor enables the production of high-quality synthesis gas from a wide variety of waste products. The use of waste products promotes a sustainable circular economy and reduces the demand for valuable hydrocarbon-containing raw materials for synthesis gas production. The use of waste products as raw materials contributes to the reduction of landfill waste and supports sustainable resource use. At the same time, the demand for fossil resources is reduced. The feed material can be supplied from a special waste material container, which serves as an intermediate storage facility and compensates for supply bottlenecks or fluctuations. This ensures smooth operation of the plant and constant production of high-quality synthesis gas. As a result, continuous utilization of the plant and a constant flow of synthesis gas can be ensured. In addition, liquid and/or gaseous substances can be added to the process. If only liquid substances are used, an evaporator can be used instead of the gasification reactor. The separation of synthesis gas production into four steps allows for low requirements on the feed material and at the same time leads to a broader applicability of the synthesis gas. Another advantage is the possibility of adding solid plastic waste to the process as feed material, which would otherwise have to be treated separately in waste processing due to disruptive chemical properties. The use of a first oxidizing agent and/or second oxidizing agent, which are fed into the gasification reactor in a variable mixing ratio, enables precise control over the gasification conditions, such as the reaction temperature and the products formed. This allows the composition of the synthesis gas to be specifically adjusted. In addition, the gasification and reforming conditions can be precisely controlled. This improves the adaptability of the process to different feed materials and product requirements. The gasification of the feed material into a hydrocarbon gas mixture and at least one by-product in step S2 represents the initial production step of synthesis gas from the feed material. Gasification is an endothermic reaction. During gasification, a carbon-containing energy feed material is converted into a gaseous hydrocarbon gas mixture and by-products by means of a chemical conversion with the addition of thermal energy. Gasification takes place at a temperature of 400-650° C. in particular. The recirculation of thermal energy from the reformer unit to the gasification reactor reduces the external energy requirement of gasification in step S2 and increases the overall energy efficiency of the process. This results in a cost-efficient and sustainable process design. In addition, the feedback of thermal energy enables a uniform supply of thermal energy to the gasification reactor, which minimizes fluctuations in energy input and enables stable synthesis gas production.

To obtain a raw synthesis gas, the hydrocarbon gas mixture is fed into a reformer unit in step S3. The subsequent treatment of the hydrocarbon gas mixture in step S4 in the reformer unit leads to the production of the raw synthesis gas with the addition of a further first and/or second oxidizing agent. The synthesis gas obtained in step S4 has a purity suitable for a variety of applications, such as chemical synthesis.

In a fourth step S4, part of the thermal energy present in the raw synthesis gas is removed and returned to the gasification reactor. This returned thermal energy provides part of the thermal energy required in S2, which in turn increases the energy efficiency of the process.

In an alternative embodiment, the process comprises a first step S1 of feeding a substantially or exclusively gaseous feed material into a reformer unit, wherein the gaseous feed material comprises hydrocarbon gas mixtures. In addition, the process comprises a subsequent step S4 of converting the essentially or exclusively gaseous feed material in the reformer unit into a raw synthesis gas with the addition of a first and/or second oxidizing agent, wherein at least part of the thermal energy released in step S4 is recirculated.

In a further preferred embodiment of the method, step S4 of treating the hydrocarbon gas mixture in a reformer unit comprises, in addition to reforming the hydrocarbon gas mixture into a raw synthesis gas in a plasma reformer, at least one step from step S44, wherein step S44 comprises cooling the synthesis gas, step S444, wherein step S444 comprises regulating the temperature of the raw synthesis gas in a thermal residence chamber to increase the reaction yield, and a step S4444, wherein step S4444 comprises quenching the raw synthesis gas in a cooling zone.

The synthesis gas can be cooled in step S44 by means of a heat exchanger, whereby the heat exchanger can return the thermal energy to the overall system via a heat transfer medium. Utilizing the thermal energy released during the cooling of the raw synthesis gas enables increased energy efficiency of the process. Positioning a heat exchanger between the thermal residence chamber and the cooling zone allows maximum utilization of the waste heat from the nearby plasma reformer and the thermal energy from the synthesis gas obtained, without impairing the reactions in the overall system. The regulation of the temperature in a thermal residence chamber in S444 serves to increase the reaction yield, destroy pollutants in the gas, and control the product composition of the raw synthesis gas. Only a small amount of thermal energy is required in the thermal residence chamber to maintain the temperature of the raw synthesis gas. Quenching the raw synthesis gas in a cooling zone in step S4444 allows the temperature of the hot raw synthesis gas to be lowered quickly. This quickly removes the existing thermal energy from the raw synthesis gas. This prevents any unwanted further reactions from taking place in the gas. Water cooling by injection is a cost-effective option for this. A further advantage is that water cooling does not impair the quality of the synthesis gas.

In a further preferred embodiment of the process, the portion of the energy released in step S4 is returned to the gasification reactor via a first and/or second oxidizing agent as a heat transfer medium.

Targeted recirculation of the energy released in step S4 into the gasification reactor via a first and/or second oxidizing agent enables a significant increase in the efficiency of the process. This integration allows optimal use of the thermal energy, further reducing the external energy requirement. The recirculation via the oxidizing agent also contributes to more flexible control of the gasification process, as the energy introduced can be precisely dosed and evenly distributed. This design not only increases process stability, but also enables finer adjustment of the reaction conditions, which contributes to the production of a consistently high-quality synthesis gas.

In a further preferred embodiment of the process, the recirculated first and/or second oxidizing agent is heated for the purpose of recirculating the thermal energy via a heat exchanger, in particular a radiant heat exchanger or a ceramic heat exchanger, between the thermal residence chamber and the cooling zone.

The post-treatment of the recirculated first and/or second oxidizing agent via a heat exchanger offers the advantage of efficient post-treatment of the recirculated first and/or second oxidizing agent, thereby optimizing its quality and reactivity for the gasification process. The use of the heat exchanger, for example in the form of an evaporator, such as a radiant heat exchanger or a ceramic heat exchanger, ensures effective heat transfer from the thermal residence chamber or the cooling zone. This allows the thermal energy from the process to be reused in a meaningful way, which increases energy efficiency and reduces the overall energy requirement of the process. In addition, post-treatment in the heat exchanger ensures homogeneous conditioning of the oxidizing agent, enabling a stable and controllable reaction in the gasification reactor. This contributes to improved process stability, consistent synthesis gas quality, and extended service life of the process components.

In a further development of the process, the thermal energy is returned via a heat exchanger between the thermal residence chamber and the cooling zone, wherein the heat exchanger heats a medium in an intermediate circuit and wherein the medium then transfers this heat to at least one heat sink via at least one second heat exchanger, wherein the at least one heat sink comprises a heat sink with a stream of first and/or second oxidizing agent.

The use of an intermediate circuit filled with a heat transfer medium for transferring the waste heat from the plasma reformer to the oxidant stream offers the advantage of lower losses when the waste heat and oxidizing agent circuits are positioned far apart. In addition, the risk of contamination between the two circuits is lower. The temperature levels of the oxidizing agent and waste heat circuits can be freely regulated by the intermediate circuit. This prevents damage to the heat exchanger due to excessive temperatures. It also enables process heat to be transferred to other consumers.

In a further development of the process, at least one superheater is included between the heat exchanger and the gasification reactor.

By using at least one superheater between the heat exchanger and the gasification reactor, the first and/or second oxidizing agent can be further heated, in particular to 650° C., in order to further increase the heat input by the first and/or second oxidizing agent into the gasification reactor. This in turn reduces the primary energy requirement of the gasification reactor and increases the efficiency of the overall process. Furthermore, the use of at least one superheater serves to control the gasification conditions in order to regulate the quantity and composition of the hydrocarbon gas mixture produced.

In a further preferred embodiment of the process, at least part of the post-treated first and/or second oxidizing agent accelerates process step S2.

The targeted use of the treated first and/or second oxidizing agent increases the reaction speed and efficiency of the gasification process, thereby achieving a faster and more complete conversion of the feed material into a hydrocarbon gas mixture. The reason for this, in addition to the heat input, is a faster removal of the reaction products from the gasification reactor. This not only improves the productivity of the process, but also the energy utilization and the consistency of the synthesis gas quality. In addition, the accelerated reaction enables a reduction in the residence time in the gasification reactor, which leads to higher throughput and more efficient use of plant resources.

In a further preferred embodiment, the process comprises separating the bottom ash produced during gasification in S2 and at least partially separating and returning fly ash produced during the conversion and carried by the hydrocarbon gas mixture to the gasification reactor, wherein the separation preferably further comprises separating the bottom ash via an ash discharge system, wherein the step of separating and returning preferably comprises separating the fly ash present in the hydrocarbon gas mixture after gasification via an ash trap, in particular via a cyclone.

Ash types such as bottom ash or fly ash are produced as by-products in gasification processes. Due to the high reaction temperature in the gasification reactor, these by-products also have a high medium temperature, which contributes to maintaining the high temperature level during gasification when they are separated and returned to the reactor. The separation and recirculation of these hot by-products contributes to increased purity of the end product of gasification and increased energy efficiency of the overall process.

An ash discharge system for separating bottom ash ensures continuous and trouble-free operation of the gasification reactor by preventing deposits and blockages. The ash discharge system enables efficient and controlled removal of the by-product, keeping operating conditions stable and extending the service life of the plant. In addition, the separate separation of bottom ash facilitates its reuse or environmentally friendly disposal. This contributes to improved sustainability of the overall process, as valuable resources can be recovered or waste can be treated properly. In addition, this ash discharge system can transport the separated bottom ash back into the gasification reactor in order to reuse the high temperature level of the ash during gasification.

The fly ash particles produced during gasification can be removed from the end product of the hydrocarbon gas mixture using ash traps, such as cyclones, or other filtering methods. Efficient removal of fly ash increases the purity of the hydrocarbon gas mixture, which improves the quality of the synthesis gas obtained from it. This serves, on the one hand, to ensure the purity of the hydrocarbon gas mixture with regard to further processing and, on the other hand, to enable the possible further utilization of what is actually an unwanted by-product. The use of a cyclone enables reliable and mechanically robust separation of particles, even at high temperatures and flow velocities, thereby increasing process stability. In addition, the targeted separation and recirculation of fly ash prevents possible deposits in downstream components, which reduces their maintenance requirements and extends the service life of the plant. The recirculation of fly ash also enables further utilization of residual materials, which increases the resource efficiency of the process and contributes to minimizing waste. Furthermore, the separation and recirculation of fly ash contained in the hydrocarbon gas mixture upstream of the plasma reformer serves to recirculate a by-product, thereby increasing the energy efficiency of the overall process. The high temperature of the fly ash in the gasification reactor is used to reduce the high energy consumption required to heat it to the necessary reaction temperature.

In a further preferred embodiment of the process, the ratio of the components hydrogen, H2, and carbon monoxide, CO, in the synthesis gas is controlled via a mixing ratio of the first oxidizing agent and the second oxidizing agent.

The ratio of hydrogen and carbon monoxide in the synthesis gas, also known as the synthesis gas ratio, is controlled by regulating the mixing ratio of the oxidizing agents supplied to the gasification reactor and the reformer unit. The synthesis gas ratio can be controlled via the mixing ratio of water vapor and carbon dioxide. This allows variable adjustment of the synthesis gas composition and quality, which also ensures consistent product quality of the synthesis gas. A constant mixing ratio of the oxidizing agents would prevent the system from adapting to fluctuating compositions of the feed material. In established processes, the mixing ratio of carbon monoxide and hydrogen is adjusted via the water gas shift reaction. This is not necessary here, which in turn saves resources and improves the energy efficiency of the overall system. The control of the synthesis gas ratio by means of the mixing ratio of the oxidizing agents is made possible by the use of non-catalytic, i.e., thermal or plasma-based, reforming in step S4.

In a further preferred embodiment of the process, the process after step S4 comprises cooling the raw synthesis gas in a condenser unit while separating a condensate.

This cooling step in a condenser unit serves to treat the raw synthesis gas in order to separate any remaining fly ash particles, salts, volatile heavy metals, and residual steam from the raw synthesis gas stream. The separated substances are then removed from the synthesis gas stream by the condensate, resulting in pure synthesis gas. In addition, the targeted reduction in temperature allows the synthesis gas to be optimally prepared for subsequent process steps, which in turn increases the efficiency and flexibility of the process. The separation of the condensate also enables the removal of unwanted accompanying substances such as water or condensable compounds, thereby improving the purity and quality of the synthesis gas. In addition, the condenser unit contributes to effective heat recirculation by extracting excess heat from the gas stream, which increases the energy efficiency of the entire process. This integration also minimizes the effort required for downstream gas purification.

In a further preferred embodiment of the process, the operating pressure of the gasification reactor and the operating pressure of the plasma reformer are between 1 bar and 20 bar, preferably 1.5 and 4 bar, absolute pressure.

The required operating pressure of the process in the reactors is between 1 bar and 20 bar absolute pressure in order to obtain a high reaction yield of synthesis gas and to enable the reaction steps of gasification and reforming. In addition, it is possible to set the operating pressure of the process in the reactors between 1.5 and 4 bar absolute pressure. Furthermore, the process steps are essentially isobaric. This also means that compressors have to work less, which is reflected in lower energy consumption. In addition, low-pressure pipes can be used in this moderate pressure range, which are less expensive than high-pressure pipes. It reduces the mechanical stress on reactor walls and components, which extends the service life of the plant and reduces maintenance costs. Choosing an operating pressure in a low range also reduces the requirements for plasma reformers used in step S4, as high gas pressure makes it difficult to operate plasma reformers stably.

In a further preferred embodiment of the method, the step of regulating the temperature of the raw synthesis gas in the thermal residence chamber comprises maintaining the temperature of the raw synthesis gas for at least two seconds at at least 850° C., preferably 1,200° C.

Keeping the raw synthesis gas at a minimum temperature of 850° C., preferably 1,200° C., for two seconds ensures combustion conditions for waste incineration plants that comply with § 6 of the seventeenth ordinance implementing the Federal Immission Control Act. This ensures that certain pollutant emission limits are met. In addition, maintaining the temperature can increase the yield of the reforming reaction. In a further preferred embodiment of the process, the first oxidizing agent comprises water vapor, H2O, and the second oxidizing agent comprises carbon dioxide, CO2.

Water vapor and carbon dioxide are used as reaction partners and oxidizing agents in gasification and reforming. The oxidizing agents water vapor and carbon dioxide are added to the overall system in an adjustable mixing ratio when participating in the reactions, whereby the mixing ratio can also consist of a pure substance. These have a significant influence on the reaction temperature and product composition. The oxidizing agents water vapor and carbon dioxide have already been tried and tested many times in technology, only limited safety precautions are necessary, and they are inexpensive to obtain. In the case of carbon dioxide, a pollutant is actually being recycled. By providing hydrogen for the reforming reaction, water vapor contributes to increasing the hydrogen content in the synthesis gas, resulting in a high-quality and versatile product. At the same time, carbon dioxide as a second oxidizing agent enables the use of a potential waste or by-product from other processes, which contributes to promoting the circular economy and reducing carbon dioxide emissions. The combination of both oxidizing agents enables precise control of the gasification and reforming conditions, as both the reaction temperature and the composition of the resulting products can be flexibly adjusted. In addition, the simultaneous use of water vapor and carbon dioxide achieves effective conversion of the feed material during gasification, thereby increasing the efficiency of the process and reducing the need for external resources. Overall, this embodiment leads to more sustainable, cost-efficient, and environmentally friendly synthesis gas production.

In a further preferred embodiment of the process, the gasification in step S2 takes place in a fluidized bed gasifier or a fixed bed gasifier or a screw gasifier or in an evaporator.

When using fluidized bed gasification in the gasification reactor, the superheated oxidizing agent serves as a liquefier of the solid bed in the gasification reactor, which speeds up the gasification process. This is achieved by the high medium temperature of the superheated oxidizing agent. Gasification in a fluidized bed gasifier offers the advantage of high variability in the feed material. In addition, there is good controllability of the feed material and gas input into the reactor, as well as good scalability over a wide power range. In screw gasification, a reactor with a rotating screw is used, whereby this screw is designed with a special geometry. This ensures optimal heat transfer of the feed material to the reactor wall and good mixing. Furthermore, comparable gasification processes can be used.

In a further preferred embodiment of the process, a substance, in particular a metal carbonate, metal oxide, metal hydroxide, or hydrogen carbonate, is added to the gasification in step S2 to bind the acid gases produced.

The addition of substances, in particular metal carbonates, metal oxides, metal hydroxides, or hydrogen carbonates, to the gasification reactor serves to bind acid gases that may be produced during the gasification reaction. Particularly when using substances containing polyvinyl chloride, acid gases, in particular hydrogen chloride or hydrogen fluoride, can be produced, which can lead to corrosion problems in subsequent process steps.

In a further preferred embodiment of the process, an arc discharge is also carried out in the plasma reformer during treatment.

The arc discharge generates a high-energy plasma that enables efficient activation and decomposition of molecules, especially of compounds in the hydrocarbon gas mixture that are difficult to convert or are stable. This leads to improved reaction efficiency and a higher yield of valuable synthesis gas components such as hydrogen and carbon monoxide. The use of the plasma reaction also allows specific reaction pathways to be stimulated in a targeted manner, enabling precise control of the product composition. In addition, the high temperature and energy of the plasma helps to optimize the conversion of residues and by-products, thereby increasing the overall economic efficiency and sustainability of the process.

In a further preferred embodiment, the process comprises separation by condensation and recirculation of impurity gases present in the synthesis gas to the reformer unit, wherein the impurity gases preferably comprise carbon dioxide, wherein the carbon dioxide preferably forms the second oxidizing agent for recirculating the thermal energy generated in step S4.

The purity requirements necessary for synthesis gas are achieved by separating off impurity gases that may be present in the synthesis gas stream. Carbon dioxide occurs in particular as an impurity gas, although other gases may also be present in the synthesis gas product stream. The separation of impurity gases can be carried out using various techniques, such as scrubbing, membrane separation, or pressure or temperature swing adsorption. The separation technique selected depends on the purity requirements of the possible subsequent process. If, for example, the synthesis gas is to be used in the phosgene route, carbon dioxide must be almost completely separated, as carbon dioxide can only be tolerated in the ppm range.

In a further preferred embodiment, the feed material supplied in step S1 essentially or exclusively comprises at least one gaseous waste product, and step S2 of gasifying the feed material is omitted.

In this embodiment, the feed material supplied in step S1 essentially or exclusively comprises at least one gaseous waste product. As a result, a subsequent step S2 of gasifying the feed material is not necessary, since the feed material is already in a gaseous state. This means that the high primary energy actually required in step S2 is not necessary and the energy requirement of the process is reduced.

Accordingly, a device for obtaining a synthesis gas from at least one waste product via a gasification reaction in conjunction with a reforming reaction under thermal energy recirculation is proposed. The device comprises a storage facility for a feed material and a first and/or second oxidizing agent, wherein the feed material comprises in particular at least one solid, liquid, and/or gaseous waste product. In addition, the device comprises a gasification reactor for gasifying the feed material by means of the first and/or second oxidizing agent with the addition of thermal energy into a hydrocarbon gas mixture and at least one by-product, wherein the by-product comprises, in particular, bottom ash and/or fly ash. The device also comprises a reformer unit for processing the hydrocarbon gas mixture into a raw synthesis gas with the addition of the first and/or second oxidizing agent and a cooling device for cooling the raw synthesis gas, wherein at least part of the thermal energy released in the reformer unit is recirculated into the gasification reactor to provide at least a portion of the thermal energy supplied to the gasification reactor.

The device feeds the waste products stored in a waste material container, which are solid but may also be in a liquid or gaseous state, to the gasification reactor. The process step of gasifying the feed material and the oxidizing agents to form a hydrocarbon gas mixture and by-products is then carried out in the gasification reactor. In addition to the heat generated, bottom ash and/or fly ash are also formed as by-products, but these are removed from the hydrocarbon gas mixture stream and recirculated into the gasification reactor in order to reuse the residual heat of the materials after gasification for reasons of energy efficiency. The hydrocarbon stream is then fed into the reformer unit, where the hydrocarbon stream and the oxidizing agents are reformed into a raw synthesis gas. In addition, steps for processing the raw synthesis gas take place in the reformer unit in order to ultimately obtain a synthesis gas.

In a preferred embodiment, the device is configured to perform the process according to one of the previous embodiments.

In addition, the process according to step S4 may comprise a scrubbing step of the acidic synthesis gas with a scrubbing solution, in particular Selexol and/or Rectisol, in a scrubbing column to provide the synthesis gas.

By scrubbing the acidic synthesis gas with a scrubbing solution, such as Selexol and/or Rectisol, the acidic synthesis gas is effectively freed from undesirable impurity gases such as carbon dioxide, hydrogen sulfide, and other acidic gases, thereby obtaining a synthesis gas with high purity. This not only increases the quality of the synthesis gas, but also its versatility for downstream applications, such as in the chemical industry or energy production. The use of Selexol and Rectisol as scrubbing solutions enables selective absorption of the acidic components and precise control of the scrubbing process. This reduces the need for additional purification steps and lowers operating costs. In addition, the scrubbing process contributes to increased plant safety by minimizing the concentration of harmful or corrosive gases in the synthesis gas. Overall, this leads to better product quality, among other things.

After a scrubbing step of the acidic synthesis gas to synthesis gas, the process may initially comprise separating off impurity gases, storing the synthesis gas in a storage tank, and preferably compressing the synthesis gas.

Storing the synthesis gas in a storage tank allows the product stream to be buffered. Buffering makes it easier to respond to fluctuating demand for synthesis gas. In addition, fluctuations in the production of synthesis gas can be compensated for. Compressing the synthesis gas not only reduces the volume required for storage, but also allows it to be fed directly into gas networks and pipelines at regulated pressure levels.

### BRIEF DESCRIPTION OF THE FIGURES

Preferred further embodiments of the invention are explained in more detail in the following description of the figures. These show:

FIGS. 1A and 1B schematically show a flow chart of a process for obtaining a synthesis gas from waste products with thermal energy recirculation;

FIG. 2A schematically shows a process for obtaining a synthesis gas from waste products with thermal energy recirculation;

FIG. 2B schematically shows a process for obtaining a synthesis gas from waste products with thermal energy recirculation using an intermediate circuit;

FIG. 3 schematically shows a post-treatment of a synthesis gas; and

FIG. 4 schematically shows a process for obtaining a synthesis gas from waste products and the post-treatment of the synthesis gas.

### DETAILED DESCRIPTION OF THE DISCLOSURE

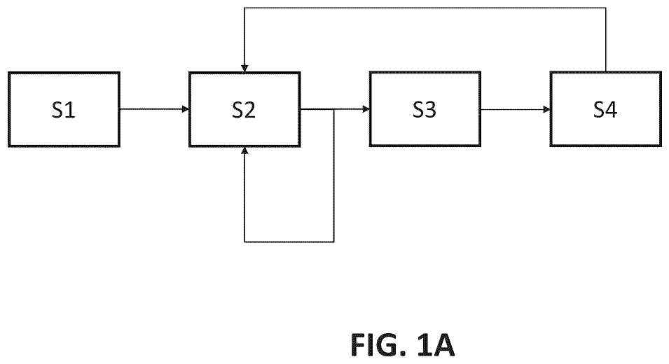

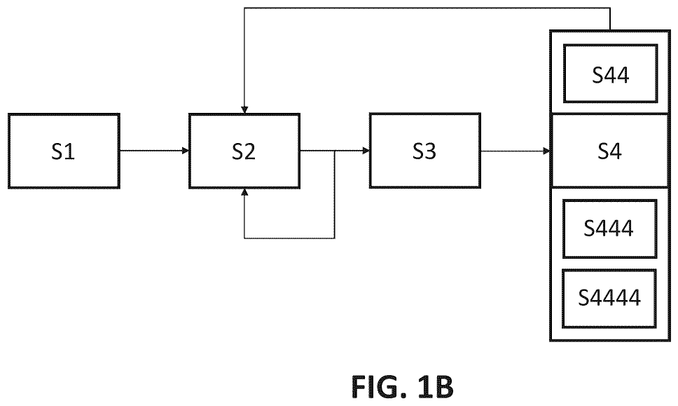

FIGS. 1A and 1B show a process for obtaining a synthesis gas from waste products in an exemplary flow chart. The flow charts show the four steps S1-S4. The first step S1 involves feeding a feed material, the second step S2 involves gasifying the feed material, the third step S3 involves feeding the hydrocarbon gas mixture into a reformer unit, and the fourth step S4 involves processing the hydrocarbon gas mixture in the reformer unit.

In the first step S1, both the feed material and an oxidant stream are fed into a gasification reactor. The oxidant stream can consist of a first and a second oxidizing agent in a controllable mixing ratio. The mixing ratio can be changed in both material directions, so that both pure substances of a first or second oxidizing agent and a mixture of the first and second oxidizing agents can be present. In the example given, the oxidant stream is understood to be a mixture of water vapor and carbon dioxide. In addition, the first and second oxidizing agents can be carbon monoxide (CO), oxygen (O2), or hydrogen (H2). The feed material may be composed of solid, liquid, and/or gaseous waste products. For example, the waste product may comprise solid plastic waste. In addition, carbon sources from the system, such as carbon dioxide or organic waste, such as biomass or sorting residues, may serve as waste products. The feed material S1 and the oxidant stream are supplied by means of a feed system. The feed system is implemented, for example, as a screw conveyor, whereby any type of feed system can be used, such as a belt conveyor, an inclined conveyor, or industrial trucks.

In a second step S2, the feed material supplied in step S1 is gasified by the oxidant stream in the gasification reactor. Due to the endothermic characteristics of the gasification reaction in S2, it is necessary to supply thermal energy. The reaction products are a hydrocarbon gas mixture and at least one by-product. In addition, two, three, four, or any number of by-products may also be produced, with various types of ash being the most common by-products. Bottom ash and fly ash are produced as by-products. The external supply of thermal energy in step S2 is necessary to provide the high process temperatures required for gasification. In the example shown in FIG. 1, the thermal energy is provided by an electric heater and thus a recirculation of hot oxidizing agent. In addition, the thermal energy can be provided by any form of heating or recirculation of thermal energy in the system. In the example shown in FIG. 1, a fluidized bed gasifier is used as the gasification reactor. In addition, an entrained flow gasifier or a fixed bed gasifier can also be used. The absolute pressure during the reaction in the gasification reactor is between 1 bar and 20 bar.

The bottom ash produced during gasification in S2 settles from the hydrocarbon gas mixture onto the reactor floor in the gasification reactor. The settled bottom ash is also separated from the gasification reactor via an ash discharge system.

The fly ash produced during gasification in a second step S2 is discharged from the fluidized bed gasifier with the hydrocarbon gas mixture at the reactor tip. The fly ash only accounts for a small amount of the material flow. After the gasification reactor, the material flow passes through an ash trap to separate the fly ash from the hydrocarbon gas mixture. The ash trap is formed by a cyclone. In addition, the ash trap can be formed by any separation system, such as a filter or adsorption.

In a third step S3, the hydrocarbon gas mixture freed of ash is fed from the gasification reactor into a reformer unit. The hydrocarbon gas mixture is fed directly into the reformer unit via pipelines, for example, to be further processed into synthesis gas. In a third step S3, the gasification reaction from step S2 and the reforming reaction in step S4 are coupled via the gasified medium. In addition, it is conceivable to incorporate intermediate steps, such as filter units or transport units for the medium, into the coupling.

In a fourth step, S4, the hydrocarbon gas mixture is processed into raw synthesis gas in the reformer unit. An oxidant stream is added to the reformer unit to enable the reaction. The oxidant stream consists of a first and second oxidizing agent in a controllable mixing ratio. The mixing ratio can be changed in both material directions so that pure substances can be present. The oxidizing agents of the oxidant stream in S4 correspond to the first and/or second oxidizing agents of the first step S1, whereby the mixing ratio may differ from the mixing ratio of the first step S1. In the example shown, water vapor is used as the first oxidizing agent and carbon dioxide as the second oxidizing agent. After the oxidant stream is added to a plasma reformer in the reformer unit, the reforming reaction to produce raw synthesis gas takes place. In addition, a steam reformer can be used instead of the plasma reformer. The plasma reformer is driven by plasma drivers. These provide the thermal energy required for the high reaction temperatures. High temperatures are required here, so that the medium outlet temperature of the plasma reformer is between 1100° C. and 1600° C. In the plasma reformer, the hydrocarbon gas mixture and the oxidant stream are mixed and a non-thermal plasma is generated. The non-thermal plasma then reforms the stream of hydrocarbon gas mixture and oxidizing agent into raw synthesis gas. The plasma reformer can carry out the reforming in the form of an arc discharge. The synthesis gas generated in the plasma reformer consists of carbon monoxide and hydrogen, the mixing ratio of which can be controlled by the mixing ratio of the oxidant stream. The absolute pressure during the reaction in the plasma reformer is between 1 bar and 20 bar. In addition, operating pressures between 1.5 bar and 4 bar are possible.

As shown in FIG. 1A, the heat exchanger can return the thermal energy released in the reformer unit in step S2. This thermal energy can in turn be used for gasification in step S2. As shown in FIG. 1B, the processing of the hydrocarbon gas mixture in step S4 can include the further steps S44: cooling the raw synthesis gas, S444: regulating the temperature of the raw synthesis gas in a thermal residence chamber to increase the reaction yield, and S4444: quenching the raw synthesis gas in a cooling zone.

In step S44, cooling the raw synthesis gas provides thermal energy, which in turn can be recirculated in step S2. In a cooling stage, part of the thermal energy transferred from the plasma reformer to the raw synthesis gas in step S4 is forwarded to a heat exchanger. In the example shown, the heat exchanger is a ceramic radiant heat exchanger. Heat exchangers made of other materials, such as iron or stainless steel, can also be used. The heat exchanger transfers the thermal energy of the synthesis gas to an oxidant stream. The oxidant stream is fed in separately and/or separated from a product stream of a synthesis gas by condensation and returned. The oxidant stream is fed to the heat exchanger. The oxidant stream is vaporized and superheated by the heat exchanger. It is also possible to vaporize only the oxidant stream. In this design, the heat exchanger is used as an evaporator. Alternatively, in step S4, the heat exchanger can first transfer the thermal energy emitted by the plasma reformer to an intermediate circuit filled with a heat transfer medium. Thermal oil is used as the heat transfer medium, although any heat transfer medium such as molten salts, liquid metals, water, alcohol-water solutions, or salt-water solutions can also be used. The heat transfer medium then transfers the thermal energy to the oxidant stream via another heat exchanger. This in turn vaporizes the oxidant stream, whereby the oxidant stream can also be vaporized and superheated. The thermal energy of the oxidant stream is then transferred to the gasification reactor in step S2. Increasing the thermal energy of the oxidant stream and recirculating the oxidant stream accelerates process step S2. This in turn can provide part of the thermal energy required in step S2.

In a further stage of step S4 of the processing of the hydrocarbon gas mixture, the temperature of the raw synthesis gas in the reformer unit is regulated in a thermal residence chamber in step S444. This regulation is achieved by maintaining the temperature at 850° C. for at least two seconds. In addition, the regulation can also take place at temperatures above 850° C. for longer than two seconds.

In a further step of the processing of the hydrocarbon gas mixture S4, the quenching of the raw synthesis gas in a cooling zone is represented in step S4444. Here, the raw synthesis gas passes through the cooling zone before being discharged from the reformer unit. Water is used for quenching, although oils or gases can also be used as alternatives. The raw synthesis gas is cooled to a temperature level at which it can be discharged from the reformer unit.

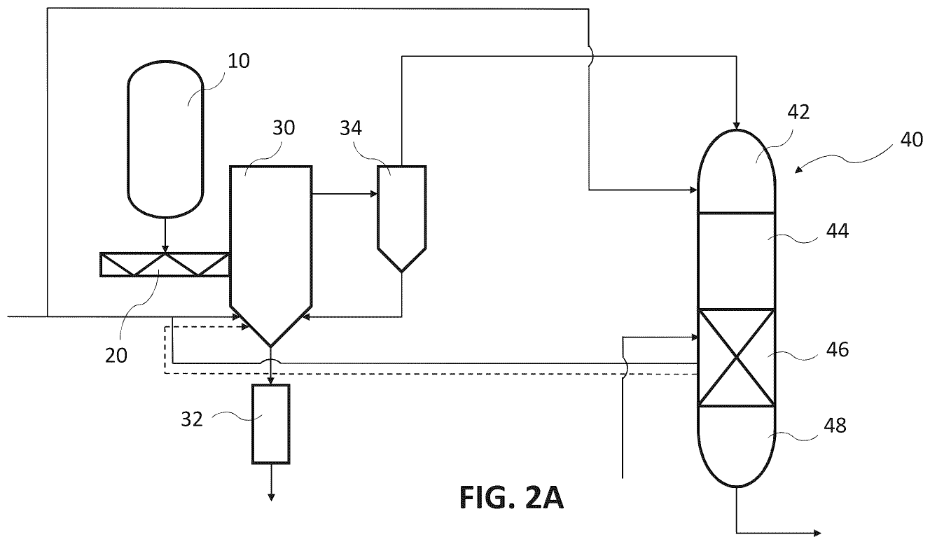

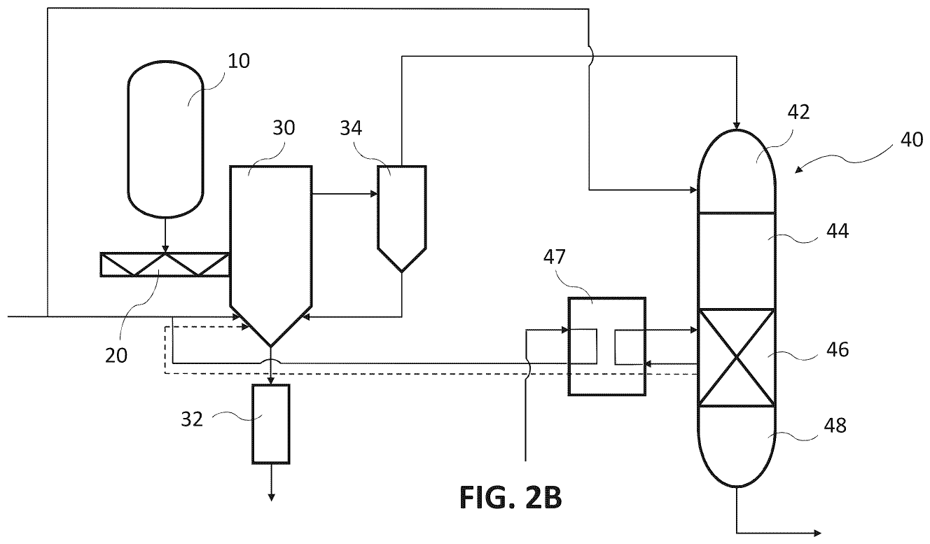

FIGS. 2A and 2B show a schematic drawing of the first stage of the process for obtaining a synthesis gas from waste products.

FIG. 2A shows a waste material container 10 in which feed material is stored. Solid plastic waste is used as feed material. The feed material is conveyed via a feed system 20 into a gasification reactor 30. The feed system 20 is designed here as a screw conveyor. In the example shown in FIG. 2A, the gasification reactor 30 is designed as a vortex gasifier. In addition, an oxidant stream is fed into the gasification reactor 30. The oxidant stream used here is a mixture of a first oxidizing agent, for example water vapor, and a second oxidizing agent, for example carbon dioxide. In the gasification reactor 30, the feed material is gasified with the oxidant stream. In addition to a hydrocarbon gas mixture, this produces ash types in the form of bottom ash and fly ash. The bottom ash produced in the gasification reactor settles at the bottom of the reactor after the reaction. The bottom ash is separated from the gasification reactor 30 by an ash discharge system 32. The fly ash is discharged with the hydrocarbon gas mixture stream at one end of the gasification reactor 30. The stream of hydrocarbon gas mixture and fly ash then passes through an ash trap 34, which in the example is designed as a cyclone. The ash trap 34 separates the fly ash present in the stream and returns this fly ash to the gasification reactor 30. The hydrocarbon gas mixture purified of fly ash is fed into a reformer unit 40 after the ash trap 34.

The reformer unit 40 contains a plasma reformer 42. The hydrocarbon gas mixture and a first and/or second oxidizing agent are fed to the plasma reformer 42 via an oxidant stream. The same oxidizing agents are used as the oxidant stream for the gasification reactor 30, although the mixing ratio may differ from the mixing ratio of the oxidant stream for the gasification reactor 30. Here, the oxidizing agents used are water vapor and carbon dioxide. After the oxidant stream is added to the plasma reformer 42, the reforming reaction to produce raw synthesis gas takes place in the reformer unit. The temperature of the raw synthesis gas is regulated in the reformer unit 40 after the plasma reformer 42 in a thermal residence chamber 44. The temperature is regulated by maintaining it at 850° C. for two seconds. The raw synthesis gas is also passed through a multi-stage cooling process. In one stage of the cooling process, the raw synthesis gas transfers part of its thermal energy to a heat exchanger 46. The heat exchanger 46 is a ceramic radiant heat exchanger. The heat exchanger 46 transfers part of the thermal energy of the raw synthesis gas to an oxidant stream, whereby the oxidant stream is fed in separately and/or is separated from a product stream of a synthesis gas by condensation and returned. The oxidant stream is vaporized, whereby the oxidant stream can also be vaporized and superheated. In this embodiment, the heat exchanger 46 is an evaporator.

As shown in FIG. 2B, the heat exchanger 46 can alternatively first transfer the thermal energy emitted by the plasma reformer 42 to the raw synthesis gas to an intermediate circuit 47 filled with a heat transfer medium. Thermal oil is used as the heat transfer medium. There are two heat exchangers in the intermediate circuit 47. In a first heat exchanger, the thermal energy transferred from the heat exchanger 46 is absorbed and transferred to the intermediate circuit. In a second heat exchanger, the thermal energy of the intermediate circuit 47 is transferred to the oxidant stream. In this process, the oxidant stream is evaporated, whereby the oxidant stream can also be evaporated and superheated. In this embodiment, the intermediate circuit serves as an evaporator.

The oxidant stream, which has been heated to increase its thermal energy, is fed into the gasification reactor 30. Increasing the thermal energy of the oxidant stream and recirculating the oxidant stream accelerates gasification in the gasification reactor 30. This provides part of the thermal energy required in the gasification reactor 30.

Furthermore, the hydrocarbon gas mixture is treated by quenching the raw synthesis gas in a cooling zone 48. The raw synthesis gas passes through the cooling zone 48 before being discharged from the reformer unit 40. Water is used for quenching. The raw synthesis gas is cooled to a temperature level at which it can be discharged from the reformer unit 40.

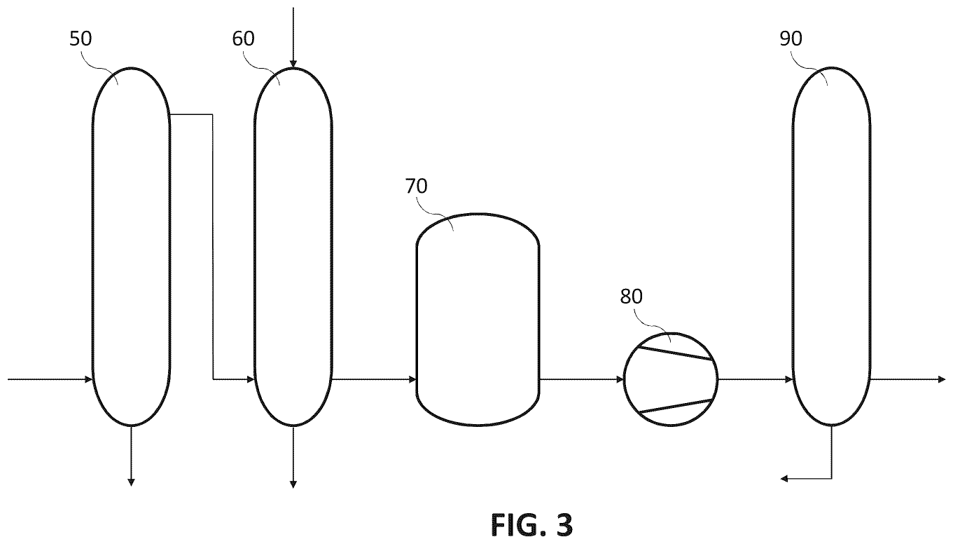

FIG. 3 shows a schematic drawing of a second stage in the production of synthesis gas from waste products. The raw synthesis gas discharged from the reformer unit is fed into a condenser unit 50. In the condenser unit, the raw synthesis gas is condensed and cooled. A condensate is separated off, whereby the condensate is separated from the raw synthesis gas at the bottom of the condenser unit 50. This produces an acidic synthesis gas, which is fed into a scrubbing column.

In the scrubbing column 60, pollutants such as halogen acids and other acid gases carried along with the acidic synthesis gas are bound in a scrubbing process using a pure scrubbing solution. The pure scrubbing solution is fed into the scrubbing column 60. Potassium bicarbonate is used as the scrubbing solution here. In addition, Selexol scrubbing or Rectisol scrubbing can also be used as a scrubbing process, in which case polyethylene glycol or methanol can be used as the scrubbing solution. The pollutants originate from the compounds in the plastic waste. The pollutants are bound to the pure scrubbing solution and separated from the synthesis gas. This produces synthesis gas and a scrubbing solution contaminated with pollutants. The synthesis gas is transferred to a storage tank 70, while the contaminated scrubbing solution with the pollutants enters a separate circuit. In this circuit, the scrubbing solution contaminated with pollutants is treated, whereby the pollutants are separated from the scrubbing solution and the pure scrubbing solution is returned to the scrubbing column 60.

A product stream of the raw synthesis gas is stored in the storage tank 70. The storage tank is designed as a container, whereby any type of storage tank can be used, such as a cavern storage tank or an absorptive storage tank. This compensates for fluctuations in the production of synthesis gas. The synthesis gas is transferred from the storage tank 70 to a compressor station 80.

The compressor station 80 compresses the synthesis gas to a higher pressure level so that it can be fed into pipelines, gas networks, or further processes. The compressor station 80 achieves this by means of compressors. One, two, three, four, or any number of compressors can be used. Further processes include, for example, chemical synthesis, fuel production, hydrogen production, or power generation.

After the compressor station 80, impurity gases are separated from the synthesis gas by condensation in a gas separator 90 and returned to the heat exchanger 46. An oxidant stream from carbon dioxide is understood to be an impurity gas, although other impurity gases from the synthesis gas can also be removed by the gas separator 90.

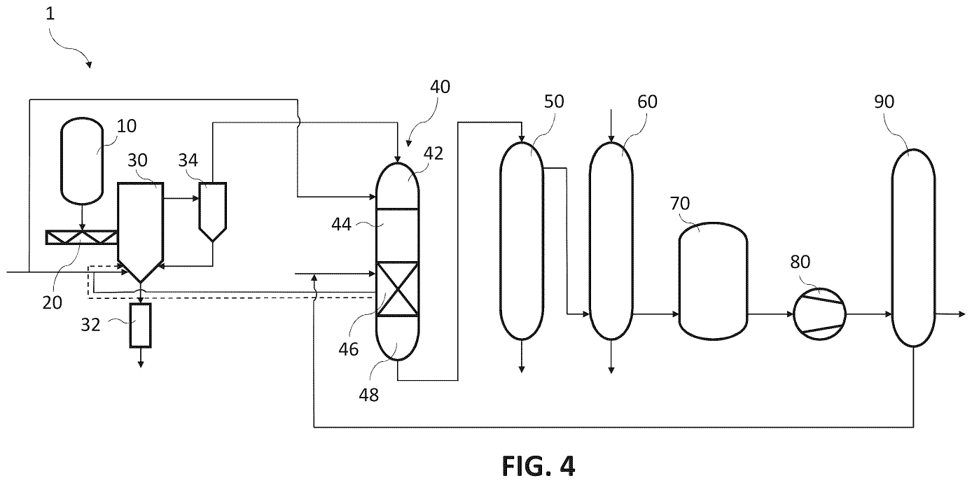

FIG. 4 shows a schematic diagram of the process for obtaining a synthesis gas from waste products. It shows a combination of the sections from FIGS. 2A and 3. Feed material is stored in a waste material container 10. Solid plastic waste is used as feed material. The feed material is transferred to a gasification reactor 30 via a feed system 20. The feed system 20 is designed as a screw conveyor. The gasification reactor 30 is a vortex gasifier. In addition, an oxidant stream is fed into the gasification reactor 30. A mixture of water vapor and carbon dioxide is used as the oxidant stream. The feed material is gasified with the oxidant stream in the gasification reactor 30. In addition to a hydrocarbon gas mixture, this produces ash in the form of bottom ash and fly ash. The bottom ash produced in the gasification reactor settles at the bottom of the reactor after the reaction. The bottom ash is separated from the gasification reactor 30 by an ash discharge system 32. The fly ash is discharged with the hydrocarbon gas mixture stream at one end of the gasification reactor 30. The stream of hydrocarbon gas mixture and fly ash then passes through an ash trap 34, which in this case is a cyclone, downstream of the gasification reactor 30. The ash trap 34 separates the fly ash present in the stream and returns this fly ash to the gasification reactor 30. The hydrocarbon gas mixture, which has been cleaned of fly ash, is fed into a reformer unit 40 after the ash trap 34.

Reformer unit 40 contains a plasma reformer 42. The hydrocarbon gas mixture and an oxidant stream are fed to the plasma reformer 42. The first and/or second oxidizing agent of the supplied oxidant stream corresponds to the first and/or second oxidizing agent of the gasification reactor 30, whereby the mixing ratio may differ from the mixing ratio of the oxidant stream of the gasification reactor 30. Here, the oxidizing agents water vapor and carbon dioxide are used. In the reformer unit 40, the reforming reaction to produce raw synthesis gas takes place in the plasma reformer 42 after the oxidant stream has been added. The temperature of the raw synthesis gas is regulated in the reformer unit 40 after the plasma reformer 42 in a thermal residence chamber 44. The temperature is regulated by maintaining it at 850° C. for two seconds. The raw synthesis gas is also passed through a multi-stage cooling process. In one stage of the cooling process, the raw synthesis gas transfers part of its thermal energy to a heat exchanger 46. The heat exchanger 46 is a ceramic radiant heat exchanger. The heat exchanger 46 transfers part of the thermal energy of the raw synthesis gas to an oxidant stream, whereby the oxidant stream is fed in separately and/or is extracted from a product stream of a synthesis gas by a gas separator 90 by condensation and returned. The oxidant stream is vaporized, whereby the oxidant stream can also be vaporized and superheated. In this embodiment, the heat exchanger 46 is an evaporator.

The oxidant stream, which has been increased in thermal energy, is fed to the gasification reactor 30. Increasing the thermal energy of the oxidant stream and recirculating the oxidant stream accelerates gasification in the gasification reactor 30. This provides part of the thermal energy required in the gasification reactor 30. In addition, the synthesis gas produced from the hydrocarbon gas mixture is treated by quenching the raw synthesis gas in a cooling zone 48. The raw synthesis gas passes through the cooling zone 48 before being discharged from the reformer unit 40. Water is used for quenching. The raw synthesis gas is cooled to a temperature level at which it is fed from the reformer unit 40 into a condenser unit 50.

In the condenser unit 50, the raw synthesis gas is condensed and cooled. During this process, a condensate is separated, whereby the condensate is separated from the raw synthesis gas at the bottom of the condenser unit 50. This produces an acidic synthesis gas, which is fed into a scrubbing column 60.

In the scrubbing column 60, pollutants such as halogen acids and other acid gases carried along with the acidic synthesis gas are bound in a scrubbing process using a pure scrubbing solution. The pure scrubbing solution is fed into the scrubbing column 60. Potassium bicarbonate is used as the scrubbing solution here. The pollutants originate from the compounds in the plastic waste. The pollutants are bound to the pure scrubbing solution and separated from the synthesis gas. This produces synthesis gas and a scrubbing solution contaminated with pollutants. The synthesis gas is transferred to a storage tank 70, while the contaminated scrubbing solution with the pollutants enters a separate circuit. In this circuit, the scrubbing solution contaminated with pollutants is treated, whereby the pollutants are separated from the scrubbing solution and the pure scrubbing solution is returned to the scrubbing column 60.

A product stream of raw synthesis gas is stored in storage tank 70. The storage tank is designed as a container. This compensates for fluctuations in synthesis gas production. The synthesis gas is transferred from storage tank 70 to compressor station 80.

The compressor station 80 compresses the synthesis gas to a higher pressure level so that it can be fed into pipelines, gas networks, or further processes. The compressor station 80 achieves this by means of compressors.

After the compressor station 80, impurity gases are removed from the synthesis gas by condensation in a gas separator 90 and returned to the heat exchanger 46. Impurity gases are understood to be carbon dioxide in particular as an oxidant stream, although other impurity gases can also be removed from the synthesis gas by the gas separator 90.

Where applicable, all individual features shown in the embodiments can be combined and/or exchanged with one another without leaving the scope of the invention.

### LIST OF REFERENCE SIGNS

1 Device
10 Waste material container
20 Feed system
30 Gasification reactor
32 Ash discharge system
34 Ash trap
40 Reformer unit
42 Plasma reformer
44 Thermal residence chamber
46 Heat exchanger
47 Intermediate circuit
48 Cooling zone
50 Condenser unit
60 Scrubbing column
70 Storage tank
80 Compressor station
90 Gas separator
S1 Feeding of feed material
S2 Gasification of feed material
S3 Feeding the hydrocarbon gas mixture
S4 Processing of the hydrocarbon gas mixture
S44 Cooling of the raw synthesis gas
S444 Regulation of the temperature of the raw synthesis gas

S4444 Quenching the raw synthesis gas

1. A method for obtaining a synthesis gas from at least one waste product via a gasification reaction in conjunction with a reforming reaction under thermal energy recirculation, wherein the method comprises the following steps:
S1: Feeding a feed material and a first and/or second oxidizing agent into a gasification reactor, wherein the feed material comprises, in particular, at least one solid, liquid, and/or gaseous waste product;
S2: Gasifying the feed material in the gasification reactor in the presence of the first and/or second oxidizing agent with the addition of thermal energy into a hydrocarbon gas mixture, wherein at least one by-product is produced, wherein the by-product comprises, in particular, bottom ash and/or fly ash;
S3: Feeding the hydrocarbon gas mixture from the gasification reactor into a reformer unit;
S4: Processing the hydrocarbon gas mixture in the reformer unit into a raw synthesis gas with the addition of the first and/or second oxidizing agent;
wherein at least a portion of thermal energy generated in step S4 is recirculated to the gasification reactor to provide at least a portion of the thermal energy supplied in step S2.

2. The method of claim 1, wherein step S4 of processing the hydrocarbon gas mixture in the reformer unit comprises, in addition to reforming the hydrocarbon gas mixture into a raw synthesis gas in a plasma reformer, at least one step from
S44: cooling the raw synthesis gas;
S444: regulating the temperature of the raw synthesis gas in a thermal residence chamber to increase the reaction yield; and
S4444: quenching the raw synthesis gas in a cooling zone.

3. The method of claim 1, wherein the portion of the thermal energy generated in step S4 is recirculated to the gasification reactor via a first and/or second oxidizing agent.

4. The method of claim 3, wherein the first and/or second oxidizing agent for returning the thermal energy is heated via a heat exchanger, in particular a radiant heat exchanger or a ceramic heat exchanger, between the thermal residence chamber and the cooling zone.

5. The method of claim 3, wherein the thermal energy is recirculated via a heat exchanger between the thermal residence chamber and the cooling zone, wherein the heat exchanger heats a medium in an intermediate circuit and the medium then transfers this heat to at least one heat sink via at least one second heat exchanger, wherein the at least one heat sink comprises a heat sink with a flow of first and/or second oxidizing agent.

6. The method of claim 3, wherein at least one superheater is included between the heat exchanger and the gasification reactor.

7. The method of claim 3, wherein at least part of the heated first and/or second oxidizing agent accelerates step S2.

8. The method of claim 1, wherein step S2 comprises separating the bottom ash produced during gasification and at least partially separating and recirculating fly ash produced during gasification and carried by the hydrocarbon gas mixture to the gasification reactor, wherein preferably the separation further comprises a separation of the bottom ash via an ash discharge system, wherein preferably the step of separating and recirculating comprises the separation of the fly ash present in the hydrocarbon gas mixture after gasification via an ash trap, in particular a cyclone.

9. The method of claim 1, wherein a ratio of the components of hydrogen, H2, and carbon monoxide, CO, in the synthesis gas is controlled via the mixing ratio of the first oxidizing agent and the second oxidizing agent.

10. The method of claim 1, wherein the method comprises, after step S4, cooling the raw synthesis gas in a condenser unit while separating off a condensate.

11. The method of claim 1, wherein the operating pressure of the gasification reactor and the operating pressure of the plasma reformer are between 1 bar and 20 bar, preferably 1.5 and 4 bar, absolute pressure.

12. The method of claim 2, wherein the step of regulating the temperature of the raw synthesis gas in the thermal residence chamber comprises maintaining the temperature of the raw synthesis gas for at least two seconds at at least 850° C., preferably 1,200° C.

13. The method of claim 1, wherein the first oxidizing agent comprises water vapor, H2O, and the second oxidizing agent comprises carbon dioxide, CO2.

14. The method of claim 1, wherein the gasification in step S2 takes place in a fluidized bed gasifier, or a fixed bed gasifier, or a screw gasifier, or in an evaporator.

15. The method of claim 1, wherein a substance, in particular a metal carbonate, metal oxide, metal hydroxide, or hydrogen carbonate, is added to the gasification in step S2 to bind the acid gases produced.

16. The method of claim 2, wherein during the treatment an arc discharge is also carried out in the plasma reformer.

17. The method of claim 3, wherein the method comprises separation by condensation and recirculation of impurity gases present in the synthesis gas to the reformer unit, wherein the impurity gases preferably comprise carbon dioxide, wherein the carbon dioxide preferably forms the second oxidizing agent for recirculating the thermal energy generated in step S4.

18. The method of claim 1, wherein the feed material supplied in step S1 comprises at least one gaseous waste product.

19. A device for obtaining a synthesis gas from at least one waste product via a gasification reaction in conjunction with a reforming reaction under thermal energy recirculation, the device comprising:
a. a storage facility for a feed material and a first and/or second oxidizing agent, wherein the feed material comprises in particular at least one solid, liquid, and/or gaseous waste product;
b. a gasification reactor for gasifying the feed material, by the first and/or second oxidizing agent and with the addition of thermal energy, into a hydrocarbon gas mixture and at least one by-product, the by-product comprising, in particular, bottom ash and/or fly ash;
c. a reformer unit for processing the hydrocarbon gas mixture into a raw synthesis gas with the addition of the first and/or second oxidizing agent ; and
d. a cooling device for cooling the raw synthesis gas,
wherein at least a portion of the thermal energy released in the reformer unit is recirculated to the gasification reactor to provide at least a portion of the thermal energy supplied to the gasification reactor.

20. The device of claim 19, wherein the device is configured to perform a method comprising:
S1: Feeding a feed material and a first and/or second oxidizing agent into a gasification reactor, wherein the feed material comprises, in particular, at least one solid, liquid, and/or gaseous waste product;
S2: Gasifying the feed material in the gasification reactor in the presence of the first and/or second oxidizing agent with the addition of thermal energy into a hydrocarbon gas mixture, wherein at least one by-product is produced, wherein the by-product comprises, in particular, bottom ash and/or fly ash;
S3: Feeding the hydrocarbon gas mixture from the gasification reactor into a reformer unit;
S4: Processing the hydrocarbon gas mixture in the reformer unit into a raw synthesis gas with the addition of the first and/or second oxidizing agent;
wherein at least a portion of thermal energy generated in step S4 is recirculated to the gasification reactor to provide at least a portion of the thermal energy supplied in step S2.
